(19) United States
(12) Patent Application Publication
(10) Pub. No.: US 2019/0043051 A1
(43) Pub. Date: Feb. 7, 2019

(54) CONTINUOUS FLOW PAYMENTS

(71) Applicant: Manfred Neustifter, Palo Alto, CA (US)

(72) Inventor: Manfred Neustifter, Palo Alto, CA (US)

(21) Appl. No.: 15/538,126

(22) PCT Filed: Dec. 22, 2015
(86) PCT No.: PCT/IB15/59903

§ 371 Date: Jun. 20, 2017

Related U.S. Application Data
(60) Provisional application No. 62/095,513, filed on Dec. 22, 2014.

(51) Int. Cl. G06Q 20/40

(52) U.S. Cl. CPC G06Q 20/405

(57) ABSTRACT

Using various embodiments, methods, devices, and systems for a continuous flow payment system (CFPS) are described. In one embodiment, the CFPS can compute a flow rate (value per unit time) of a user's income and expenses and display the user's account balance in real time. The CFPS can also instruct the payment of a user's financial obligations and manage a user's finances.

### TECHNICAL FIELD

Embodiments of the invention relate generally to the field of managing one's finances. More particularly, embodiments of the invention relate to a payment system which allows money to flow continuously via an account holder's account.

### BACKGROUND OF INVENTION

Financial transactions are conducted in a static environment, wherein a financial transaction tends to be constrained to a specific point in time. In this paradigm, in a two part transaction, a payee (e.g., wage earner) performs an activity delivering monetary value to the payor (e.g., company). The payee has to wait for a transaction to be initiated and settled in order to satisfy the outstanding debts resulting from the exchange of services wages. Thus, during the performance of the activity, the payee accrues a deficit of monetary value in the form of an outstanding debt until the payor settles the exchange, even if the payor immediately pays at the end of the service activity.

The banking and payments industry has developed technology to achieve instantaneous funds clearance. Yet even with instantaneous funds clearance, the transactions must be initiated and settled at some point in time (usually upon completion of a transaction). However, such a system has its limitations by inherently only supporting static transactions. In other words, existing payment systems have not resolved the delay in remuneration to balance value equilibrium in exchange because it is subject to the rules of static exchange. Thus, using existing systems, the monetary value exchange is not balanced in real time by virtue of the fact that the payment for a transaction (e.g., remuneration) must happen at one point in time.

Therefore, what is desired are payment methods, systems, and devices that can provide continuous flows of money to and from a user's account, at a relevant flow rate per unit time.

### SUMMARY OF INVENTION

The purpose of the invention, its methods, devices, and systems, is to deploy a payment system that delivers a real time monetary value exchange mechanism, in which a payee is being compensated in real time as they are engaged in activity that earns remuneration, as well as paying out in real time for resources they are consuming. In one embodiment, the invention provides a payment system which allows continuous flows of money in order to balance monetary value exchange in real time, to keep value exchange in equilibrium, while a service is rendered or consumed. Such a payment system can serve to prevent the payee accruing a monetary value deficit while waiting to be paid for service rendered for a duration of activity. In another embodiment, the system can operate by making remuneration funds available immediately, continuously, in real time based on an actual account monetary value of a user, or a prediction thereof.

As used throughout this disclosure, a monetary value (or value) can be pertaining to goods and/or remuneration. Furthermore, production (or increase) of a monetary value means performance of a task through which the monetary value is earned by the account holder as a payee. Consumption (or decrease) of a monetary value refers to an engagement through which the monetary value is deducted of the account holder provided to another party as the payor. A flow rate, as described herein means a monetary value accrued or consumed per unit time.

In one embodiment, the user's account holds a dynamic balance that changes with respect to the unit time interval, according to the continuous state of net monetary value delivered and/or consumed, rather than just according to the monetary value of one of more static transactions. Thus, with respect to the current state of production and consumption of monetary value, a user's account serviced by such a system provides continuous flows of money ready to be available to receive remuneration, available to meet ongoing commitments, available for ad hoc transactions and ready to allocate surplus according to the instructions provided by the user.

In one embodiment, the payment system includes a financial data feed from a user's financial institution (e.g., bank, credit card account, gift card account, another user's account, etc.) through which a user's account accumulates monetary value continuously when the payee is delivering monetary value e.g., while delivering service. Thus, money is flowing to the payee's account continuously while the service is being performed by the user. While the payee is engaged in activity which generates earnings due, the payment system facilitates continuous money flow simultaneously balancing the monetary value delivered in service rendered and monetary value due in kind for remuneration, thus maintaining value equilibrium of the user.

In one embodiment, the system can also serve the purpose of not incurring a monetary value surplus, that is, the system can avoid the delay of accounting for the monetary value already consumed and monetary value being consumed. The outcome gives a more accurate reading of a user's available funds and true value equilibrium state, knowing all suppliers' accounts are accounted for. To ensure the payor is not accruing a monetary value surplus, that is, not delaying payment for the monetary value of resources already delivered by the supplier, the payment system flow rate can deduct from the payor's balance continuously while the resources are delivered by the payee simultaneously.

In another embodiment, the system described herein can be used in combination with conventional ways of performing static transactions between a payor and payee. In this embodiment, the system can predict in real time the monetary value incurred by the payor and credit the monetary value to the payee's account while the payee performs the required task, thereby consuming the monetary value. Further, the relationship of flows could be direct between the payor and payee, or intermediated via CFPS and the user's ledger of static transactions.

In one embodiment, the combined effect of the continuous money flow serves the purpose to deliver continuous real time monetary value exchange equilibrium. Automating monetary value exchange in real time provides a useful benefit to the account holder, as a payee and as a payor. Thus, there is no delay in receiving the benefit of monetary value due to the payee, and less risk of insufficient funds for obligations as the payor's system has accounted for the amount due for payment. As such, the payee can use the accumulating funds and immediately allocate to their benefit according to their preference, investing, saving or using funds to consume immediately. Further, a payor can receive an added advantage of a bill management payment system that has the ability to automatically prevent defaults, lateness, or cost of insufficient funds.

In yet another embodiment, by the purpose of automating monetary value exchange in real time ensures the account holder is operating with their true available surplus funds, after accounting for monetary value they have rendered and monetary value they have consumed. The payment systems can automate cash management leaving the account holder with a compellingly simple product, a single number which has all budgeting accounted, providing the account holder the surplus available to allocate financial resources as they desire. In another embodiment, the true available funds include the credit available to the user from a credit card account.

In one embodiment, the system is capable of assigning a category to each activity/input performed. Once items are categorized and matched, with triggers set where appropriate, CFPS can determine flow rate value(s), the continuous rate of money flow which will account for predictable items by recognizing whether the user is engaged in an activity, for example: when earning remuneration or not. The flow of money modifies the available funds of the payees account. The rate of flow of credit or debit applied to the account balance will result in a continuous increasing or decreasing of the payees account balance. At any point in time during a given period, the flow rate component can only be in one state, a positive or negative rate, which is the money movement inflow or outflow in congruence with the activity the payee is engaged in. The payee can be engaged in one of two possible types of activity, activity that does not earn remuneration or activity that earns remuneration.

Firstly, while the payee is engaged in an activity that does not attract remuneration, the nominal monetary value of the feed is an outflow of money, a rate of debit applied to the balance equivalent to the sum of all deduction flow values, each of which are determined by their nominal monetary value per unit of time. Secondly, while the payee is engaged in an activity that does attract remuneration, the nominal monetary value of the feed is an inflow of money, a rate of credit applied to the balance equivalent to the sum of all income values, each of which are determined by their nominal monetary value per unit of time. While the payee is engaged in an activity that does attract remuneration, the feed flow accounts for the sum of individual feed flows determined by the rate of income monetary value minus the rate of deduction in value, resulting in a combined feed value. While a payee is engaged in an activity that has been identified to earn remuneration a surplus feed monetary value would result. Thus, at any given time, an accurate representation of a user's account balance can be provided to the user.

### BRIEF DESCRIPTION OF DRAWINGS

The present invention is illustrated by way of example and not limitation in the figures of the accompanying drawings in which like references indicate similar elements.

FIG. 1 illustrates a block diagram of a continuous flow payment system (CFPS) as described in one embodiment of the invention.

FIG. 2 illustrates a flow chart describing the operations of the CFPS, as described in one embodiment of the invention.

FIG. 3 illustrates a flow chart describing the operations of categorizing an input or activity, according to one embodiment of the invention.

FIG. 4 illustrates a block diagram describing the CFPS providing a dynamic balance of a user's CFPS account while receiving financial inputs and activities, according to one embodiment of the invention.

FIG. 5 illustrates a flow chart that determines the category of an activity or input related to a financial event, as described in one embodiment of the invention.

FIG. 6 illustrates a block diagram that describes the dynamic balance update of a user's CFPS account, as described in one embodiment of the invention.

FIG. 7 illustrates a computer system that can be used to describe any computing device used in the implementation of the CPFS, as described in any embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described can be performed in a different order. Moreover, some operations can be performed in parallel rather than sequentially.

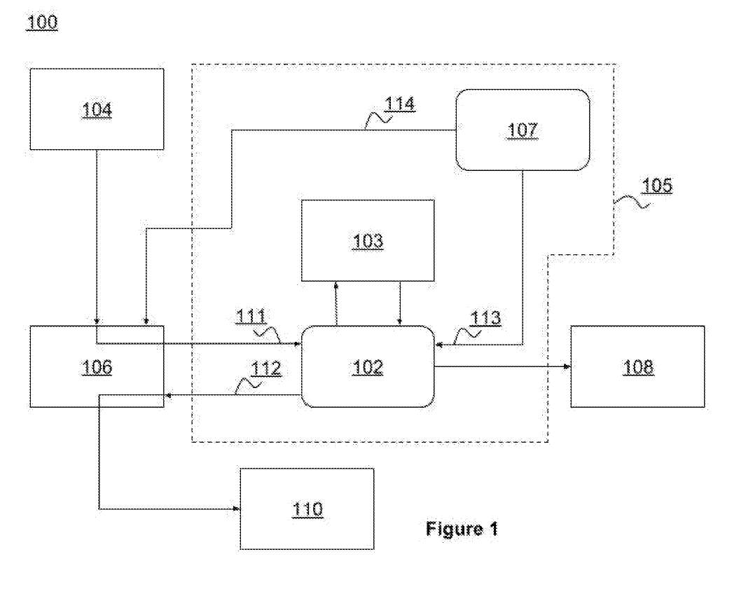

FIG. 1 illustrates a block diagram 100 describing an overview of a continuous flow payment system (CFPS) as described in one embodiment of the invention. After a user creates CFPS account 102 with CFPS 105, the user provides CFPS 105 information about their income (e.g., remuneration), time interval after which the income is received (e.g., weekly, biweekly, monthly, etc.), and optionally authorization to deduct the income from a user's financial institution 104. Based on the information provided by the user, CFPS 105 computes a flow rate of the user's income where the flow rate is the monetary value of the user's income per unit time. A unit time, as defined throughout this disclosure is a predetermined or configured (user or system) time interval which is used to compute the user's income flow rate, and represents a measure of the user's monetary value for that time interval. Similarly, the user provides CFPS their account information that will pertain to any financial obligation the user may have (e.g., bills, mortgage, loans, electricity/water meter readings, etc.) using which CFPS calculates the user's expense flow rate (expenses per unit time). In combination, CFPS calculates the user's surplus flow rate, accounting for income flow rate and expense flow rate.

In one embodiment, the user using their financial institution 104 provides funds to a static transaction ledger 106. In another embodiment, the user's funds are automatically debited from the user's financial institution 104 account. Static transaction ledger 106 maintains the transactions of the accumulations and deductions of funds of a user enrolled with the CFPS 105 and having account 102.

Based on a user's static transaction ledger value, at every unit time, CFPS 105 credits an equivalent number/value to a income monetary flow value to a user's account 102, while maintaining the funds in static transaction ledger 106. This can be useful because, in one embodiment, the static transaction ledger 106 can be maintained as a separate system than the CFPS 105, for security reasons, only transmitting the amount value of user's funds to the CFPS 105 (not the actual funds). The CFPS then computes the monetary flow rate and credits the user account with the flow rate at every time interval defined by the unit time, without transmitting actual funds from the static transaction ledger 106. In one embodiment, the user's account value is maintained/stored at CFPS database 103. CFPS 105 can also deduct funds from a user's CFPS account 102 based on a configuration of external accounts to which the user has financial obligations to pay. In one embodiment, a user's expenses monetary flow rate is computed and an equivalent fund value is deducted from the user's CFPS account 102. CFPS database 103 can store the deducted funds value and maintain it for the user. The user's CFPS account value 102 will thus present an updated account balance of the user in real time, at every time interval. The user's CFPS account balance 102 can then be displayed to a user (as shown at 108), so the user can know their current net worth in real time. In one embodiment, display device 108 can be a tablet, wearable device, mobile device, laptop, desktop, or any computing device that is capable of communicating, and/or receiving information from CFPS 105.

Once the deductions of a user's expenses are accumulated at CFPS database 103, on a predetermined date/time, CFPS 105 can instruct that funds equivalent to the accumulated deduction value be paid to the user's external accounts 110 using the funds deposited in the static transaction ledger 106. In one embodiment, CFPS 105 is configured to compute the expenses monetary flow rate equivalent to a user's financial obligations during the predetermined period of time. Thus, in such a manner, CFPS 105 will pay a user's monthly financial obligations within the prescribed period, automatically or with notification and manual authorization by the user.

In another embodiment, the system can be designed to fund user's CFPS account 102 using another user's CFPS account 107. For example, CFPS account 107 can be an account belonging to an employer and CFPS account 102 can be an account of the employee. In this example, the remuneration of the user of CFPS account 102 can be funded in real time using the monetary flow rate of their remuneration. Thus, the employees' CFPS account 102 can be funded directly while the employers CFPS account 107 will be simultaneously deducted based on the flow rate of the user's remuneration. In such an embodiment, CFPS 105 can link the two users while money flows directly or periodically at a predetermined/configured time (e.g., every hour or day or the regular static interval). CFPS can instruct that the true remuneration value from the static transaction ledger (not shown) of CFPS user 107 be deducted, and credit the equivalent amount to static transaction ledger 106 that maintains the true account value of CFPS user 102 directly or periodically at the predetermined/configured time. Thus, when CFPS 105 determines to pay the financial obligations 110 of user 102, the funds can be readily withdrawn from static transaction ledger 106 to pay the obligations of user 102. In one embodiment, CFPS ensures that the true remuneration funds belonging to CFPS account user 102 are transferred to static transaction ledger 106 (from the static transaction ledger of the another user) before the financial obligations 110 are due for user of CFPS account 102. In another embodiment, CFPS 105 let's the user set goals (amounts), to deduct portions of surplus (account balance). In another embodiment, CFPS 501 also let's the user take charge/hold on card limit, based on credit risk.

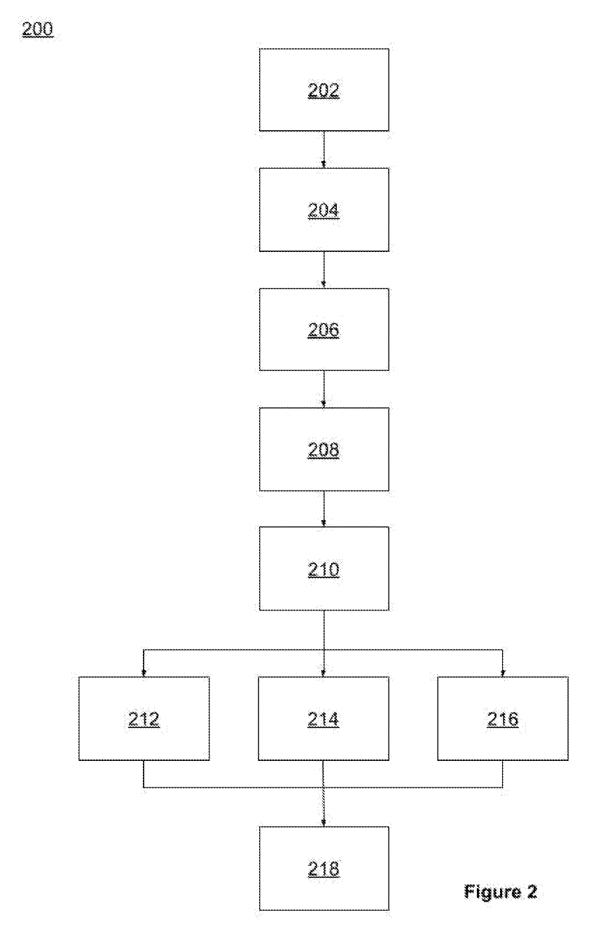

FIG. 2 illustrates a flow chart 200 describing the operations of the CFPS as described in one embodiment of the invention. At 202 the user creates an account with the CFPS and enables a digital wallet that can optionally be linked with a financial institution. Optionally at 204, a physical card (e.g., Mastercard, Visa, American Express, etc.), can be issued and linked with the user's account. The physical card can be used to make ad hoc transactions and have the funds deducted from the user's CFPS account. At 206, the user provides CFPS information pertaining to various accounts belonging to the user. As a nonlimiting example, the accounts can be a user's bank account, loan account, electricity or water accounts, mortgage account, etc. In one embodiment, the account information provided by the user can be an account number, a meter number, a sensor, or any other information that has the capability of linking the user to a service (financial or nonfinancial). At 208 CFPS receives information regarding financial input/activities and/or external sensors/account information associated with the various external accounts, the CFPS processes the information provided by the user and links the external accounts with the system described herein. In one embodiment, the information received by the user is transmitted to a trusted thirdparty which verifies the information provided by the user. In another embodiment, a trusted thirdparty maintains the account information and the user's financial balance (for example, static transaction ledger 106 can be maintained by another party with whom CFPS can communicate).

Based on the information received by CFPS at 208, at 210, CFPS can attempt to categorize the various accounts based on their input/activities. As shown at 212, a category of a fixed recurring input or activity can include a user's income, loan payments, mortgage payments, rent, or any financial transaction that occurs (and repeats) at a known time interval with a fixed value, etc. As shown at 214, a category of a varying recurring input/activity can include transactions or activities that recur at a fixed time interval, but whose value may change over the time interval. For example, such inputs/activities can be a user's electricity or water bills, meter readings taken at the end of the time interval, monthly passes (e.g., transportation, entertainment), etc. As shown in 216, a third category can be defined in which the input/activities are considered unpredictable, that is inputs/activities that can occur at varying amounts at varying time intervals (e.g., ad hoc transactions, sales of assets, purchase of fuel, random smart meter readings etc.). At 218 CFPS can set policies or alternatively prompt user to provide payment policies(e.g., customized due date, amount, payment frequency, when to pay bills, amount to pay—minimum balance or in full, user notifications, reminders, etc.) for the account information provided above.

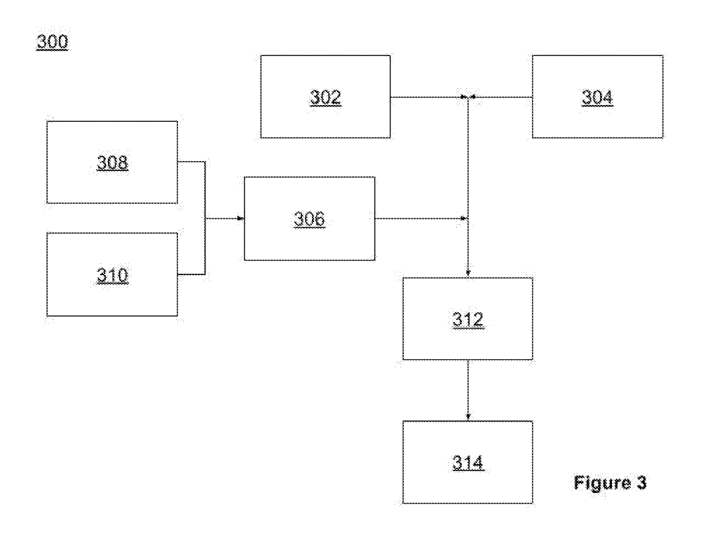

FIG. 3 illustrates a block diagram 300 providing an overview of how the various categorized information is used to pay the user's financial obligations. At 302, for each fixed recurring event a flow rate is computed. The flow rate is the value of the input/activity per unit time, which is explained in detail further herein. For each fixed recurring activity/input, compute the user's net flow rate (value of input per unit time). At 304, for each varying recurring activity/input, the flow rate is computed. Each flow rate is transmitted to update a user's CFPS account balance, thereby incrementing or decrementing the CFPS account balance 312 of the user. 306 represents an Ad hoc/ unpredictable activity/input is determined that may occur, in one embodiment, due to an activity by the user using physical card 308 or digital wallet 310. 306 can also represent an activity of depositing cash or a when physical card 308 is a gift card credited to the user's account 312. At an occurrence of an unpredictable activity/input, the complete value of the unpredictable activity (income or expense) is credited or debited from the user's CFPS account 312. At 314 depending on the system and/or user policies set (e.g., at 218), CFPS can authorize to pay a user's financial obligations for account information provided earlier (e.g., at 206) Instruct to pay user's financial obligations/bills predetermined times to user's external account.

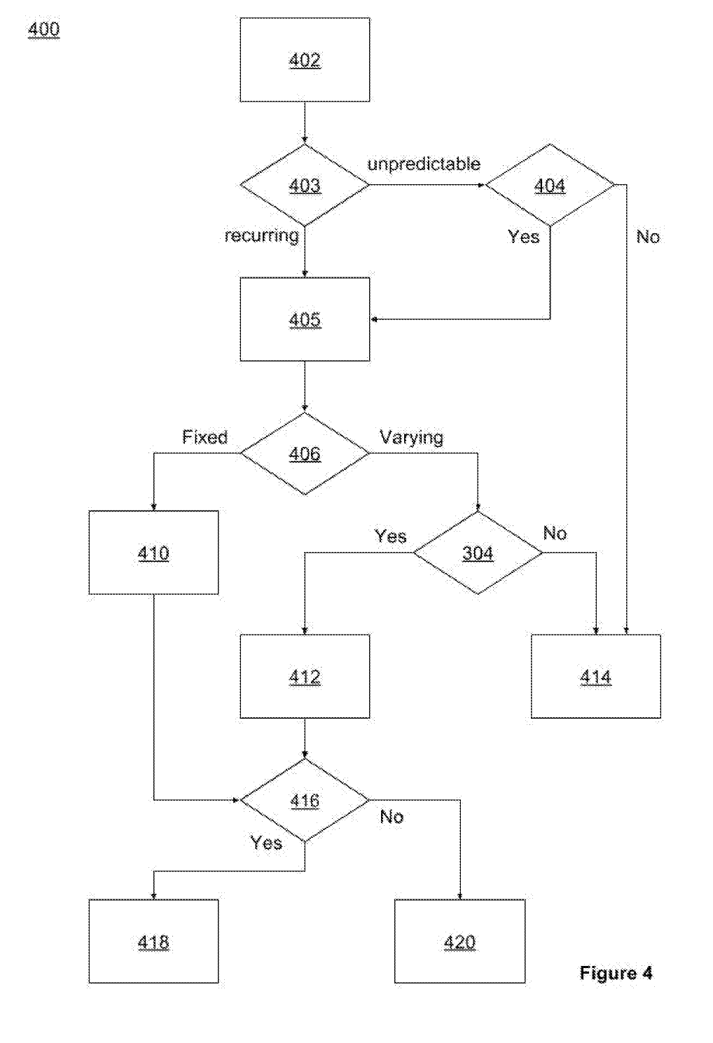

FIG. 4 illustrates a flow chart 400 that determines the flow rate that is credited or debited from a user's CFPS account based on the category of an input/activity or transaction, as described in one embodiment of the invention. At 402, CFPS determines the category of an input/activity. At 403, it is determined if the input/activity is a recurring or unpredictable event. At 404, if the activity/input is determined to be unpredictable, the system attempts to predict if the activity/input can be considered as a recurring event based on similar past inputs/activities or transactions. If they system fails to determine a recurring pattern, then control flows to 414 and the input/activity is considered as an unpredictable; the complete amount of the unpredictable event is credited/deducted from the user's CFPS account to satisfy the activity. However, if a recurring pattern is determined, the activity is considered recurring and control passes to 405 where the recurring period of the input/activity or transaction is determined in unit time. In one embodiment, CFPS is preconfigured with the unit time. In another embodiment, CFPS provides the user multiple options out of which the user selects a unit time to be used. In yet another embodiment, the user has complete control to select a unit time based on their individual preferences. Next, at 406, CFPS determines if the recurring activity is categorized as fixed or varying. If the category of the recurring event is determined to then control flows to 410 where the value of the recurring activity/input is determined for the recurrence period. For example, if the fixed recurring event is a user's remuneration of $1000 every week, then in one embodiment, the value of the user's remuneration will be $1000. If however, the input/activity is a varying recurring event, then, at 408, the system attempts to detect if similar varying recurring events have occurred in the past. If no such past recurring event is determined, the control passes on to 414 and the activity/input is again considered to be an unpredictable event; the complete value of the activity/input is credited/debited from the user's CFPS account. If however, similar past activities are determined, then using the past values CFPS attempts to predict the value of the input/activity for the recurrence period of the activity/input. In another embodiment, especially in cases where the activity/input involves a smart meter reading (e.g., gas/electric), instead of predicting the recurring value for the recurring period, CFPS can, receive the meter reading from the service provider or metering device, and maintain or update the user's resource consumption value (and thus the flow rate) accordingly. In other words, in case of varying recurring events, instead on relying on to predict the value of the recurring event, CFPS can, receive the true value of the resources consumed or received, and determine the flow rate, for the predetermined period of time. In another embodiment, the flow rate(s) determined using the predetermined period of time can be used to predict future flow rates to predict a flow rate very close to the actual flow rate over the recurring time period.

Further, each input/activity may or may not occur over a complete 24 hour period. At it is determined if the input/activity occurs only during a scheduled time period or trigger. If a trigger exists, then the recurring activity flow rate is determined only for the corresponding scheduled time interval or trigger, as shown at 418. For example, if a user receives remuneration only during business hours, Monday to Friday, then the system would credit the user's CFPS account with the remuneration flow rate only during the specified time interval, as shown at 418. Similarly triggers (e.g., geo location, time of the day, external feed, etc.) can be used during which a certain input/activity credits or debits the user's CFPS account.

If however, no such trigger or scheduled time interval is determined, then control flows to 420 where CFPS determines the flow rate using the entire recurring period. For example, a user can pay rent or mortgage to live at their residence. Because the user is living there continuously (or has the right to use the residence continuously), without interruption for the recurring time period, the flow rate would be determined using the rent or mortgage value divided by the recurring time period (e.g., a month) in unit time.

The flow rate of an activity/input can further be explained with nonlimiting examples. For example, in one embodiment, a user's income flow rate can be calculated by dividing the remuneration due, wherein workdays are 8 hours for 20 days that month. It should be noted, in this example, in this embodiment, scheduled salary working hours trigger the payment flow at the relevant intervals during work hours of work days. Thus, using one second as the unit to measure time, then the user's remuneration income flow would be the remuneration value due (e.g., $5760) divided by one month in seconds, that is 576,000 seconds (20×8×60×60), thereby having a income flow rate of 0.01. As another example, if a user has a financial obligation to pay rent of $1000 per month, and where that month has 30 days, the rent flow rate with unit time one second (30×24×60×60), would be rent divided be the (unit time in a month). That is, $1000/2,592,000 or approximately 0.000385802469 Thus, in the above example, a user's CFPS account will credit at a rate $0.000385802469 through every 1 second interval, transferring value $0.01 through 25.92 second intervals, meeting the obligation of $1000 when rent is due. Although the above example used one second as the unit time, the unit time can be of any chronological value (e.g., minute, second, nanosecond, etc.) since it does not alter the rate nor the value transferred by any point in time.

In one embodiment, the denomination of the accounts can be in multiple currencies, the feed monetary value can be measured in any currency, or by the monetary value of a tradable units such as a Bitcoin. In another embodiment, the feed monetary value can be measured in any by any unit of time. It should be noted, changing the unit of time (e.g. seconds to nanoseconds) does not change the rate of flow of money because the rate of flow is relative to time.

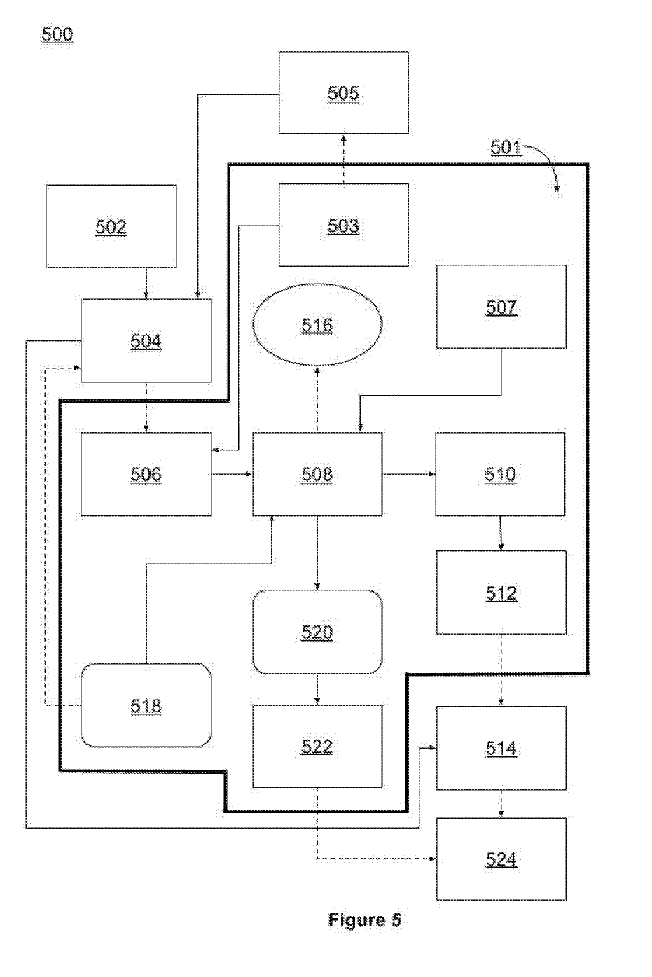

FIG. 5 illustrates a block diagram 500 describing a complete financial system including the interactions with the CFPS according to one embodiment of the invention. In one embodiment, CFPS 501 is an independent system that can interact with a user's financial institutions 502 (e.g., bank, credit card, etc.) on predetermined dates/ time intervals (for incoming funds), and external accounts 524 to which the user is obligated to pay using a static transaction ledger 504. As used herein, static transaction ledger 504 is intended to be encompassing a broad meaning, and can be any device or mechanism using which a user's finances can be moved/transferred, or used for financial recordkeeping, from one financial institution to another. In one embodiment, static transaction ledger 504 maintains the transactions of the accumulations and deductions of funds of a user enrolled with the CFPS 501 and having account 508.

In one embodiment, after the user opens a CFPS account 508, a static transaction can be performed on behalf of CFPS to deduct funds from the user's financial institution, as represented by block 502. The funds from the static transaction are then, in one embodiment, stored in a static transaction ledger 505 on behalf of the user. In one embodiment, static transaction ledger 505 is part of the CFPS 501. In another embodiment (and in the preferred embodiment), static transaction ledger 505 is maintained and control by another system. This is due to financial security reasons. Although CFPS 501 primarily offers to track a user's current balance in real time, and can also request payments to be made on behalf of the user, while provisioning between accounts no financial transaction occurs from within CFPS 501 itself, in the preferred embodiment. While CFPS 501 is expected to be a secure system, security is paramount for any device performing financial transactions. Thus, although not necessary, a person of ordinary skill in the art would appreciate the desire to separate the static transaction ledger 505 and CFPS 501.

In one embodiment, CFPS 501 is configured to provide value from another CFPS user's account as represented by 503 Income source is another user's CFPS Account. In such an embodiment, the value provided by user account 503 is directly credited to user's CFPS account 508 based on the flow rate calculated by either by the configuration values for CFPS account user 503, or as provided by CFPS user account configurations 507. The flow rate of funds accumulated in user's CFPS account 508 is credited, as represented at 506. In this embodiment, CFPS can also provide instructions to periodically deduct the financial value from the static transaction ledger 505 (Value deducted from the another user's static transaction ledger at predetermined time/date) associated with the other user's CFPS account holder 503. The deducted funds can then be provided to static transaction ledger 504 (Transaction/funds are stored in a static transaction ledger on behalf of user) to cover the user's financial obligations as disclosed further herein. Thus, in such an embodiment, CFPS 501 is capable to handing inputs/activities/transactions between two CFPS account holders.

In one embodiment, CFPS 501 can be provided the financial account balance of the user from static transaction ledger 504. Based on CFPS user account configuration 507, CFPS 501 computes a flow rate for a transaction in the static transaction ledger 504. In one embodiment, CFPS user account configuration 507 includes information about a user's remuneration value and recurring period of the remuneration. CFPS user account configuration 507 can also include the user's bill pay preferences and/or any system configuration pertaining to the user that is used by CFPS 501. As represented by 506, equivalent to the funds received at static transaction ledger 504, a numerical value starts accumulating into the user's CFPS account 508 based on the flow rate (in another embodiment, using CFPS user account configurations 507). CFPS 501 also deducts the equivalent numerical value to user's obligations out from user's CFPS account based on the expenses flow rate (value of expenses per unit time), in real time, as represented at 510. At 512, the deducted numerical value is accumulated by CFPS on behalf of the user. In one embodiment, CFPS 501 uses database 103 for such accumulations. As represented by 514, periodically, CFPS 501 can instruct that financial obligations up to the user's accumulated deductions should be paid to the user's external account holders to whom the user has financial obligations using funds available at static transaction ledger 504. In one embodiment, CFPS 501 is guaranteed to pay the user's known financial obligations using funds equivalent to the value accumulated at 512 because the value accumulated depends on the flow rate of the user's obligations already known to CFPS 501. As represented at 524 Update user's balance in static transaction ledger with deductions paid to external accounts/merchants, the static transaction ledger 504 is updated with the deducted amount used to pay the user's known financial commitments. CFPS 501 can also be configured to process unpredictable events/ ad hoc transactions/activities/inputs, that is, activities/inputs/transactions with no determined flow rate. At 518, Ad hoc transactions/unpredictable income or credits are provided (e.g., gift card value) balance maintained in the static transaction ledger; equivalent funds credited to User's CFPS account. Such a value is immediately credited to both the user's CFPS account 508 and the static transaction ledger 504 representing that the funds are now available. As represented at 520, Ad hoc/unpredictable input/activities/transactions are debited from the user's CFPS account 508 and used to fulfill the unpredictable event as represented at 522 CFPS pays funds to fulfil input/activity, or when other connected card/ account is used the CFPS adjusts balance after receiving information about transaction. CFPS 501 can then instruct the user's static transaction ledger be updated accordingly, as represented at 524.

The CFPS account 508 of the user indicates the user's present account balance and fluctuates at every unit time based on if the activity/input provided an incrementing flow rate (e.g., remuneration) or an decrementing flow rate (e.g., deducting the value per unit time for a bill). The user's CFPS account value can be incremented or decremented by the flow rate which is provided by a feed component. Thus, at any time during a given period, the feed component can only be in one state, positive or negative, and the money movement inflow or outflow, in congruence with the activity the payee is engaged in. This value fluctuation, thus dynamic account balance, can be displayed to the user, in real time as represented at 516. As disclosed above, in one embodiment, display device 516 can be a tablet, wearable device, mobile device, laptop, desktop, or any computing device that is capable of communicating, and/or receiving information from CFPS 501. In another embodiment, CFPS 501 is the system represented at CFPS 105 of FIG. 1.

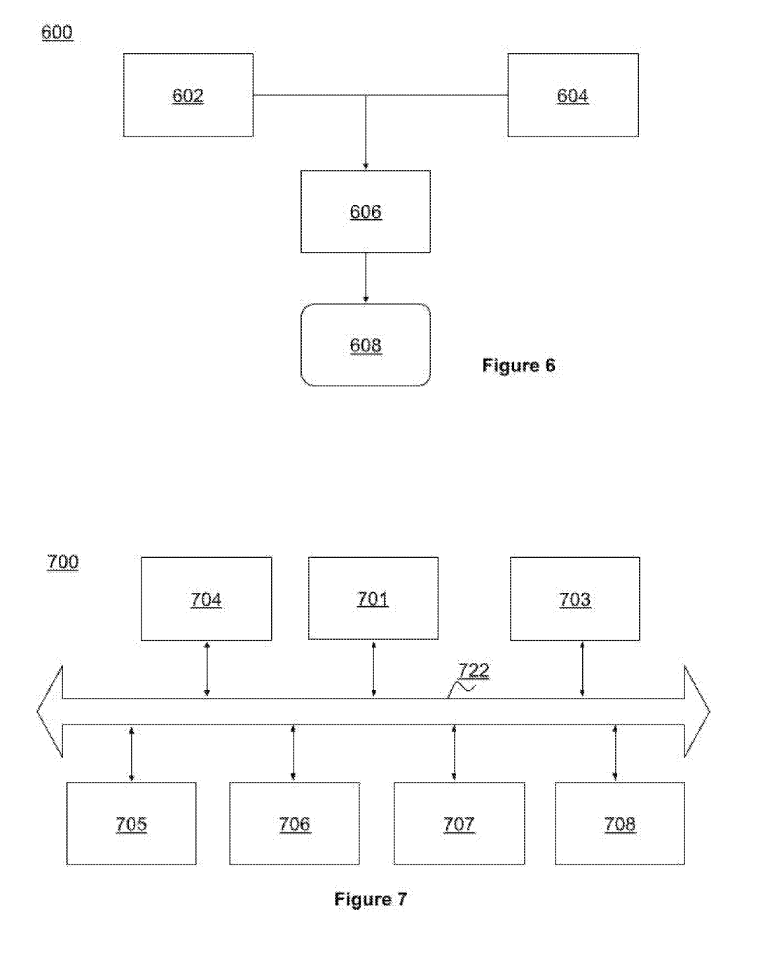

FIG. 6 illustrates a block diagram 600 that describes the dynamic balance update of a user's CFPS account, as described in one embodiment of the invention. As represented at 602, each recurring activity (fixed/ varying) flow rate is computed and incremented or decremented from a user's CFPS account balance 606 User's CFPS account. Also, for each unpredictable activity/input/transaction, the complete activity/transaction/input value is deducted from user's CFPS account 606, as represented at block 604 Complete value of Ad hoc/unpredictable input/activity are incremented/decremented. As the account value of the user's CFPS account keeps on changing based on the flow rate and unpredictable transactions, at 608, at each unit time, the user's current account balance is displayed to the user.

The techniques shown in the figures can be implemented using computer program instructions (computer code) and data stored and executed on one or more electronic systems (e.g., computer systems, etc.). Such electronic systems store and communicate (internally and/or with other electronic systems over a network) code and data using machine-readable media, such as machine-readable non-transitory storage media (e.g., magnetic disks; optical disks; random access memory; dynamic random access memory; read only memory; flash memory devices; phase-change memory). In addition, such electronic systems typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device.

It should be apparent from this description that aspects of the present invention may be embodied, at least in part, in software. That is, the techniques may be carried out in a computer system or other computer system in response to its processor, such as a microprocessor, executing sequences of instructions contained in memory, such as a ROM, DRAM, mass storage, or a remote storage device. In various embodiments, hardware circuitry may be used in combination with software instructions to implement the present invention. Thus, the techniques are not limited to any specific combination of hardware circuitry and software nor to any particular source for the instructions executed by the computer system. In addition, throughout this description, various functions and operations are described as being performed by or caused by software code to simplify description. However, those skilled in the art will recognize what is meant by such expressions is that the functions result from execution of the code by a processor.

FIG. 7 is a block diagram illustrating a data processing system such as a computing system 700 which may be used with one embodiment of the invention. For example, system 700 may be implemented as part of a continuous flow payment system. In one embodiment, system 700 may represent any computing described herein in this disclosure. System 700 may have a distributed architecture having dispersed units coupled through a network, or all of its components may be integrated into a single unit.

For example, computing system 700 may represents any of data processing systems described above performing any of the processes or methods described above. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 700 is intended to show a high level view of many components of the computer system. However, it is to be understood that additional or fewer components may be present in certain implementations and furthermore, different arrangement of the components shown may occur in other implementations. System 700 may represent a desktop, a laptop, a tablet, a server, a mobile phone, a programmable logic controller, a personal digital assistant (PDA), a personal communicator, a network router or hub, a wireless access point (AP) or repeater, a set-top box, or a combination thereof.

In one embodiment, system 700 includes processor 701, memory 703, and devices 705-708 via a bus or an interconnect 722. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra low voltage processor, may act as a main processing unit and central hub for communication with the various components of the system. Such processor can be implemented as a system on chip (SoC). In one embodiment, processor 701 may be an Intel® Architecture Core™-based processor such as an i3, i5, i7 or another such processor available from Intel Corporation, Santa Clara, Calif. However, other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments.

Processor 701 is configured to execute instructions for performing the operations and methods discussed herein. System 700 further includes a graphics interface that communicates with graphics subsystem 704, which may include a display controller and/or a display device.

Processor 701 may communicate with memory 703, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 207-2E (published April 2007), or a next generation LPDDR standard to be referred to as LPDDR3 that will offer extensions to LPDDR2 to increase bandwidth. As examples, 2/4/8 gigabytes (GB) of system memory may be present and can be coupled to processor 87 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 703 can be a machine readable non-transitory storage medium such as one or more volatile storage (or memory) devices such as random access memory (RAM), dynamic RAM (DRAM), synchronous DRAM (SDRAM), static RAM (SRAM), or other types of storage devices such as hard drives and flash memory. Memory 703 may store information including sequences of executable program instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 700 may further include IO devices such as devices 705-708, including wireless transceiver(s) 705, input device(s) 706, audio IO device(s) 707, and other IO devices 708. Wireless transceiver 705 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, network interfaces (e.g., Ethernet interfaces) or a combination thereof.

Input device(s) 706 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO device 707 may include a speaker and/or a microphone to facilitate voice-enabled functions, such as voice recognition, voice replication, digital recording, and/or telephony functions. Other optional devices 708 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 708 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 707 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on RE-initiation of system activities. Also a flash device may be coupled to processor 701, e.g., via a serial peripheral interface (SPI). This flash device may provide for non-volatile storage of system software, including a basic input/output software (BIOS) as well as other firmware of the system.

Note that while system 700 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Thus, methods, apparatuses, and computer readable medium to implement a continuous flow payment system are described in various embodiments of the innovative subject matter disclosed herein. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method, to perform a continuous flow payment system, the method comprising:
receiving, by a computing device, funds, or a numerical value thereof, from a account, wherein the funds pertain to a first activity or input related to a user;
computing an income flow rate based on the first activity or input, wherein the flow rate includes a first financial value per unit time;
accumulating the income flow rate in an account pertaining to the user;
computing an expense flow rate based on a second activity or input, wherein the flow rate includes a second financial value per unit time;
deducting the expense flow rate from the account pertaining to the user; and dynamically updating the account balance of the user at unit time.

2. The method of claim 1, further comprising:
a transaction ledger, wherein the transaction ledger accumulates the funds pertaining to a user, and wherein the funds are used to provide payments to an external account associated with the input or activity related to the user.

3. A system comprising:
a memory device;
a processing device coupled to the memory device, the processing device configured to operate to:
receive funds, or a numerical value thereof, from a account, wherein the funds pertain to a first activity or input related to a user;
compute an income flow rate based on the first activity or input, wherein the flow rate includes a first financial value per unit time;
accumulate the income flow rate in an account pertaining to the user;
compute an expense flow rate based on a second activity or input, wherein the flow rate includes a second financial value per unit time;
deduct the expense flow rate from the account pertaining to the user; and
dynamically update the account balance of the user at unit time.

4. A non-transitory computer readable medium comprising instructions which when executed by a processing device executes a method to perform a continuous flow payment system, the method comprising:
receiving funds, or a numerical value thereof, from a account, wherein the funds pertain to a first activity or input related to a user;
computing an income flow rate based on the first activity or input, wherein the flow rate includes a first financial value per unit time;
accumulating the income flow rate in an account pertaining to the user;
computing an expense flow rate based on a second activity or input, wherein the flow rate includes a second financial value per unit time;
deducting the expense flow rate from the account pertaining to the user; and dynamically updating the account balance of the user at unit time.
